(19) United States
(12) Patent Application Publication
(10) Pub. No.: US 2024/0107284 A1
(43) Pub. Date: Mar. 28, 2024

(54) METHOD FOR CUSTOMER SERVICE, COMPUTING DEVICE, AND COMPUTER STORAGE MEDIUM

(71) Applicant: PATEO CONNECT+ Technology (Shanghai) Corporation, Shanghai (CN)

(72) Inventors: Ying LIU, Shanghai (CN); Yunlin MU, Shanghai (CN)

(21) Appl. No.: 18/039,122

(22) PCT Filed: Nov. 26, 2021
(86) PCT No.: PCT/CN2021/130859

§ 371 Date: May 26, 2023

(30) Foreign Application Priority Data
Nov. 26, 2020 (CN) 202011343487.5

(51) Int. Cl. H04W 4/90; B60R 21/0132; H04W 4/02

(52) U.S. Cl. CPC H04W 4/90; B60R 21/01332; H04W 4/02

(57) ABSTRACT

A method for customer service includes: determining whether a user terminal is inside a vehicle, the vehicle being associated with the user terminal; in response to the user terminal being determined to be inside the vehicle, obtaining a first detection signal of a sensor of the user terminal; in response to the first detection signal satisfying a pre-determined condition, generating an event identifier indicating an occurrence of a collision event, the pre-determined condition being associated with change characteristics of a detection signal in a pre-determined vehicle collision process; obtaining location information of at least one of the user terminal or the vehicle; and transmitting the event identifier and the location information to a customer service device for the customer device to initiate a call to the user terminal in response to receiving the event identifier to confirm a connection status of the user terminal.

### CROSS-REFERENCE TO RELATED APPLICATION

This application claims priority to Chinese Patent Application No. 202011343487.5, filed with the China National Intellectual Property Administration (CNIPA) on Nov. 26, 2020, the entire content of which is incorporated herein by reference.

### TECHNICAL FIELD

The present disclosure relates to the technical field of information technologies and, more particularly, to a method for customer service, a computing device, and a computer storage medium.

### BACKGROUND

In the traditional solution for customer service, especially in the customer service solution for the Internet of Vehicles, a customer service system provides traffic information for vehicles logged in an Internet of Vehicles information network platform. In the event of an accident, users or passengers in the same vehicle often call rescue agencies through their respective user terminals in order to seek rescue. In the above solution, if the user or the passenger of the vehicle in the collision is injured, and the rescue agency cannot be called in time, or the location of the collision cannot be clearly described after the rescue agency is called, it will delay the rescue agency to provide timely and accurate rescue. As a result, the user and the vehicle in the collision cannot be rescued in time, and a road section where the collision occurs may be congested or a secondary traffic accident may occur. In the traditional solution for customer service, since the customer service system does not know a status and a specific location of the vehicle in the collision and other accident, especially when the user or the passenger cannot actively call the rescue agency or the customer service system due to injury or other reasons, it is unlikely to provide timely and accurate assistance to the vehicle and the user in accidents such as collision.

Thus, in the traditional solution for customer service, it is difficult to timely and accurately identify the state of the vehicle collision and other accidents, so as to provide assistance to the vehicle and the user in the collision and other accidents.

### SUMMARY

The present disclosure provides a method for customer service, a computing device, and a computer-readable storage medium, capable of timely and accurately identifying a status of vehicle collision and other accidents, thereby providing assistance to the accident vehicle or the user.

The present disclosure also provides a method for customer service, a computing device, and a computer-readable storage medium, capable of timely initiating a call after identifying a status of vehicle collision and other accidents, thereby providing assistance to the accident vehicle or the user.

One aspect of the present disclosure provides a method for customer service. The method includes: determining whether a user terminal is inside a vehicle, the vehicle being associated with the user terminal; in response to the user terminal being determined to be inside the vehicle, obtaining a first detection signal of a sensor of the user terminal; in response to the first detection signal satisfying a pre-determined condition, generating an event identifier indicating an occurrence of a collision event, the pre-determined condition being associated with change characteristics of a detection signal in a pre-determined vehicle collision process; obtaining location information of at least one of the user terminal or the vehicle; and transmitting the event identifier and the location information to a customer service device for the customer device to initiate a call to the user terminal in response to receiving the event identifier to confirm a connection status of the user terminal.

Optionally, the vehicle is a moving vehicle.

Optionally, the sensor at least includes a gyro sensor and an acceleration sensor.

Optionally, determining whether the first detection signal satisfies the pre-determined condition includes: based on the first detection signal, generating a first detection signal curve; calculating a similarity between the first detection signal curve and a pre-determined curve, the pre-determined curve indicating the change characteristics of the detection signal in the pre-determined vehicle collision process; and in response to the similarity being determined to fall within a pre-determined threshold range, determining that the first detection signal satisfies the pre-determined condition.

Optionally, generating the first detection signal curve based on the first detection signal includes: in response to an amount of change of the first detection signal being determined to exceed a pre-determined change threshold, determining whether the change characteristics of the first detection signal match pre-determined characteristics indicating a drop of a mobile phone; and in response to the change characteristics of the first detection signal not matching the pre-determined characteristics indicating the drop of the mobile phone, generating the first detection signal curve.

Optionally, the method further includes: in response to the called user terminal being determined to be connected, generating a response message of the user terminal; and in response to no response message being determined to be received from the user terminal within a pre-determined time interval, initiating a call to another user terminal associated with the user terminal, the identifier of the associated user terminal being stored in the customer service device.

Optionally, the method further includes: in response to at least one of following conditions being satisfied, generating and transmitting a rescue signal by the customer service device: receiving no response message of the user terminal within the pre-determined time interval; and receiving a positive response of a user regarding the occurrence of the collision event. The rescue signal at least indicates the location information and the identifier of the vehicle, and the identifier of the vehicle is pre-stored in the customer service device through a pre-determined application.

Optionally, transmitting the rescue signal includes: based on the location information, searching, through the pre-determined application, other user terminals and other vehicles that are located within a pre-determined range from the vehicle and logged into the pre-determined application; and transmitting the rescue signal to the other user terminals and vehicle-amounted devices of the other vehicles.

Optionally, the method further includes: obtaining an acceleration detection signal of an acceleration sensor of the vehicle; and generating an acceleration curve of the vehicle based on the acceleration detection signal.

Optionally, generating the event identifier indicating the occurrence of the collision event in response to the first detection signal being determined to satisfy the pre-determined condition includes: in response to the first detection signal being determined to satisfy the pre-determined condition, confirming a first time corresponding to a peak value of the first detection signal curve generated based on the first detection signal; determining a corresponding time of a peak segment of the acceleration curve of the vehicle; determining whether the first time is associated with the corresponding time of the peak segment; and in response to the first time being determined to be associated with the corresponding time of the peak segment, generating the event identifier indicating the occurrence of the collision event.

Optionally, determining whether the user terminal is inside the vehicle includes: obtaining a traveling speed of the vehicle; obtaining a communication connection status of the vehicle-mounted device of the vehicle and the user terminal; and based on the traveling speed and the communication connection status, determining whether the user terminal is inside the vehicle.

Another aspect of the present disclosure provides a computing device. The computing device includes: a memory configured to store one or more computer programs; and a processor coupled to the memory and configured to execute the one or more computer programs for the computing device to perform the disclosed method.

Another aspect of the present disclosure provides a non-volatile computer-readable storage medium storing machine executable instructions. When being executed by a machine, the machine executable instructions cause the machine to perform the disclosed method.

Another aspect of the present disclosure provides a method for customer service. The method includes: determining whether a user terminal is inside a vehicle, the vehicle being associated with the user terminal; in response to the user terminal being determined to be inside the vehicle, obtaining a first detection signal of a sensor of the user terminal; in response to the first detection signal satisfying a pre-determined condition, generating an event identifier indicating an occurrence of a collision event, the pre-determined condition being associated with change characteristics of a detection signal in a pre-determined vehicle collision process; obtaining location information of at least one of the user terminal or the vehicle; and transmitting the event identifier and the location information to a customer service device and initiating a call to the customer service device.

The summary is provided to introduce a selection of concepts in a simplified form that are further described below in the detailed description. The summary is not intended to identify key features or principal characteristics of the disclosure, nor is it intended to limit the scope of the disclosure. Other features of the present disclosure will become readily understood from the following description.

### BRIEF DESCRIPTION OF THE DRAWINGS

FIG. 1 is a schematic diagram of an exemplary system 100 of a method for customer service according to some embodiments of the present disclosure;

FIGS. 2A and 2B are flowcharts of exemplary methods for customer service according to some embodiments of the present disclosure;

FIG. 3 is a flowchart of an exemplary method for generating and transmitting a rescue signal according to some embodiments of the present disclosure;

FIG. 4 is a flowchart of an exemplary method for generating an event identifier for indicating an occurrence of a collision event according to some embodiments of the present disclosure;

FIG. 5 is a schematic diagram of an exemplary acceleration curve of a vehicle in a collision according to some embodiments of the present disclosure;

FIG. 6 is a schematic diagram of a sensor detection signal curve in a process of dropping a user terminal according to some embodiments of the present disclosure;

FIG. 7 is a schematic diagram of data exchange in an exemplary method for customer service according to some embodiments of the present disclosure; and

FIG. 8 is a schematic structural diagram of an exemplary electronic device according to some embodiments of the present disclosure.

In various drawings, a same or corresponding reference numeral denotes a same or corresponding part.

### DETAILED DESCRIPTION OF THE EMBODIMENTS

Various embodiments of the present disclosure will be described in more detail below with reference to the accompanying drawings. While the embodiments of the present disclosure are shown in the drawings, it should be understood that the present disclosure may be embodied in various forms and should not be limited by the embodiments set forth herein. Rather, the embodiments are provided such that the present disclosure will be thorough and complete, and will fully convey the scope of the disclosure to those skilled in the art.

As used herein, the term “including” and variations thereof mean open-ended inclusion, that is, “including but not limited to”. The term “or” means “and/or” unless specifically stated otherwise. The term “based on” means “based at least in part on”. The terms “one example embodiment” and “one embodiment” mean “at least one example embodiment.” The term “another embodiment” means “at least one additional embodiment.” The terms “first”, “second”, etc. may refer to different or the same objects. Other explicit and implicit definitions may also be included below.

As described above, in the traditional solution for customer service, because the customer service system does not know the status and specific location of the accident such as a vehicle collision, especially when the user or the passenger cannot actively call for the rescue agency or the customer service system due to injury or other reasons, it cannot timely and accurately provide assistance to the vehicle and the user in the collision and other accidents. Thus, in the traditional solution for customer service, it is difficult to timely and accurately identify the status of the vehicle collision and other accidents, and it is difficult to provide assistance to the vehicle and the user in the collision and other accidents.

To at least partially address one or more of the above-described issues and other potential issues, various embodiments of the present disclosure provide a solution for customer service. In the solution, a detection signal of a sensor of a user terminal inside the vehicle is obtained. If it is determined that the detection signal satisfies a pre-determined condition associated with a characteristic indicating a change of the detection signal during the collision of a pre-determined vehicle, an event identifier is generated and location information of the user terminal and/or the vehicle is obtained. The present disclosure can automatically and timely identify the status of the vehicle collision and other accidents. In addition, the generated event identifier and the obtained location information are transmitted to a customer service device, such that the customer service device can call the user terminal according to the event identifier. Alternatively, the generated event identifier and the acquired location information are transmitted to the customer service device while a call for rescue is also made to the customer service device. The customer service device can timely and accurately obtain the relevant location, automatically contact the user terminal in time to confirm the exact status of the vehicle collision and other accidents, and further obtain information about the user and the vehicle. As such, the status and location of the vehicle collision and other accidents can be more accurately confirmed.

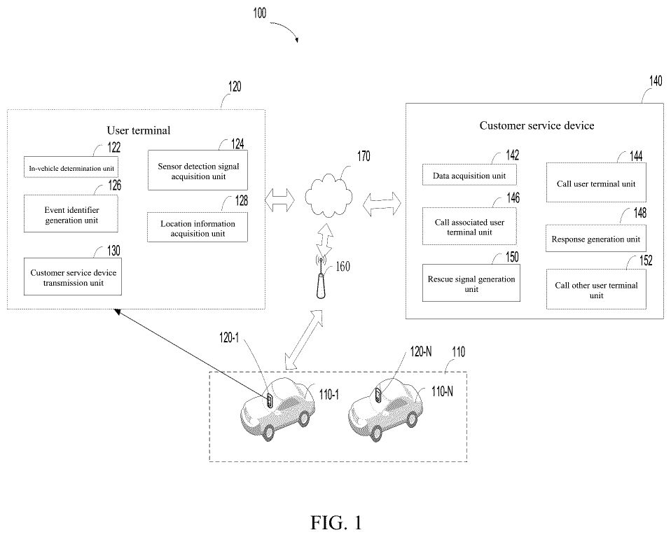

FIG. 1 is a schematic diagram of an exemplary system 100 of a method for customer service according to some embodiments of the present disclosure. As shown in FIG. 1, the system 100 includes a plurality of vehicles 110 (e.g., a current vehicle 110-1, other vehicles 110-N), a plurality of user terminals 120 of users of the plurality of vehicles (e.g., user terminal 120-1 to user terminal 120-N), a customer service device 140, a base station 160, and a network 170. In some embodiments, the current vehicle 110-1 and the other vehicle 110-N are traveling in different areas, which are separated by a distance smaller than or equal to a pre-determined distance (e.g., 5 km). The plurality of vehicles 110, the plurality of user terminals 120, and the customer service device 140 may exchange data through the base station 160 and the network 170.

For example, the customer service device 140 may be a computing device configured to receive the event identifier indicating an occurrence of a collision event and location information of at least one of the user terminal 120 or the vehicle 110, and to call the user terminal 120 in response to receiving the event identifier. The customer service device 140 may include one or more processing units. The one or more processing units may include special-purpose processing units, such as a graphics processing unit (GPU), a field programmable gate array (FPGA), and an application specific integrated circuit (ASIC), and general-purpose processing units, such as a central processing unit (CPU). As shown in FIG. 1, the customer service device 140 may include, but is not limited to, a data acquisition unit 142, a call user terminal unit 144, a call associated user terminal unit 146, a response generation unit 148, a rescue signal generation unit 150, and a call other user terminal unit 152.

The data acquisition unit 142 is configured to receive the event identifier indicating the occurrence of the collision event, and the location information of the user terminal and/or the vehicle. The event identifier and the location information are originated from the user terminal 120. In some embodiments, the location information may also be originated from the vehicle 110 occupied by the user terminal 120.

The call user terminal unit 144 is configured to call the user terminal 120 in response to receiving the event identifier from the user terminal 120.

The call associated user terminal unit 146 is configured to call an associated user terminal associated with the user terminal in response to receiving no response information from the user terminal in a pre-determined time interval. Identification information of the associated user terminal is stored at the customer service device. For example, the associated user terminal is a user terminal of an emergency contact of the user 120.

The response generation unit 148 is configured to determine whether the called user terminal is connected, and to generate the response information of the user terminal in response to a connection with the called user terminal being determined.

The rescue signal generation unit 150 is configured to generate and transmit a rescue signal in response to receiving no response information from the user terminal in the pre-determined time interval or in response to receiving a positive response of from the user about the occurrence of an event. The rescue signal at least includes the location information and identification information of the vehicle. The identification information of the vehicle may be stored at the customer service device in advance by a pre-determined application.

The call other user terminal unit 152 is configured to, based on the location information, search, by the pre-determined application, other user terminals and other vehicles that are located within a pre-determined distance and log in the pre-determined application. The call other user terminal unit 152 is further configured to transmit the rescue signal to the other user terminals and vehicle-mounted devices of the other vehicles.

For example, the user terminal 120 may include, but is not limited to, a tablet computer, a mobile phone, and a wearable device, etc. The user terminal 120 is configured to determine whether the user terminal is inside the vehicle 110 (e.g., a moving vehicle); obtain a detection signal of the a sensor of the user terminal 120 in response to the user terminal being determined to be inside the vehicle 110; generate the event identifier indicating the occurrence of the collision event and obtain the location information of at least one of the user terminal or the vehicle in response to the detection signal being determined to match a pre-determined curve; and transmit the event identifier and the location information to the customer service device 140. The user terminal 120 may directly exchange data with the vehicle-mounted T-BOX, and may exchange data with the customer service device 140 through the base station 160 and the network 170. In some embodiments, the user terminal 120 may establish an association with the vehicle 110 by detecting a pre-determined action on the user terminal 120 (e.g., a shake). As shown in FIG. 1, for example, the user terminal may include, but is not limited to, an in-vehicle determination unit 122, a sensor detection signal acquisition unit 124, an event identifier generation unit 126, a location information acquisition unit 128, and a customer service device transmission unit 130.

In some embodiments, the user terminal 120 may initiate an active call to the customer service device 140 while transmitting the event identifier and the location information to the customer service device 140. Alternatively, the user terminal 120 may also control a call module of the vehicle 110 to initiate an active call to the customer service device 140 through the connection with the vehicle 110 while transmitting the event identifier and the location information to the customer service device 140.

In some embodiments, a specific manner of invoking a call function of the user terminal 140 to initiate an active call to the customer service device 140 is provided below. While the user terminal 120 transmits the event identifier and the location information to the customer service device 140, the application program (e.g., a vehicle connected application program) running on the user terminal 120 invokes the call function of a system program of the user terminal 120 through an application program interface (API) and inputs a customer service phone number corresponding to the customer service device 140 as a parameter passed number. The system program receives a call request from the application and determines whether an ongoing call is present. In absence of the ongoing call, the system program makes an outgoing call according to the received parameter passed number, and at the same time launches a conversation interface. In presence of the ongoing call, the system program initiates a query to the user to confirm whether to disconnect the ongoing call. If the user agrees to disconnect the ongoing call, the system program disconnects the ongoing call, and initiates the outgoing call according to the received parameter passed number. If the user refuses to disconnect the ongoing call, the system program cancels a dial-out task.

In some embodiments, a specific manner that the user terminal 120 controls the call module of the vehicle 110 to initiate the active call to the customer service device 140 through the connection with the vehicle 110 is provided below. While the use terminal 120 transmits the event identifier and the location information to the customer service device 140, the application program (e.g., a vehicle connected application program) running on the user terminal 120 invokes the call function of the vehicle system through an API provided by the vehicle and inputs the customer service phone number corresponding to the customer service device 140 as the parameter passed number. The vehicle system receives a call request from the user terminal 120 and determines whether an ongoing call is present. In absence of the ongoing call, the vehicle system makes an outgoing call according to the received parameter passed number, and at the same time launches the conversation interface. In presence of the ongoing call, the vehicle system initiates a query to the user to confirm whether to disconnect the ongoing call. If the user agrees to disconnect the ongoing call, the vehicle system disconnects the ongoing call, and initiates the outgoing call according to the received parameter passed number. If the user refuses to disconnect the ongoing call, the vehicle system cancels the dial-out task.

It should be noted that, to achieve the invocation of the system call function by the application program, the application program needs to obtain authorization of the user in advance before invoking the call function to initiate the call. In the case of controlling the vehicle 110 to initiate the active call, it is often necessary to pre-authorize the active invocation of the call function of the vehicle 110.

The vehicle internal determination unit 122 is configured to determine whether the user terminal is inside the vehicle associated with the user terminal.

The sensor detection signal acquisition unit 124 is configured to obtain a first detection signal of the sensor of the user terminal in response to the user terminal being determined to be inside the vehicle. For example, the sensor detection signal acquisition unit 124 obtains the first detection signal of a gyro sensor and/or an acceleration sensor of the user terminal.

The event identifier generation unit 126 is configured to determine whether the first detection signal satisfies a pre-determined condition (the pre-determined condition is associated with a change characteristic of the detection signal indicating a pre-determined vehicle in an impact process), and to generate the event identifier indicating the occurrence of the collision event in response to the first detection signal being determined to satisfy the pre-determined condition.

The location information acquisition unit 128 is configured to obtain the location information of at least one of the user terminal or the vehicle.

The customer service device transmission unit 130 is configured to transmit the event identifier and the location information to the customer service device 140, such that in response to receiving the event identifier, the customer service device 140 initiates the call to the user terminal 120 to confirm the user terminal 120 is connected.

For example, the vehicle 110 may at least include a vehicle-mounted device (e.g., a video audio entertainment system or VAES), a vehicle-mounted data sensing device, a vehicle-mounted T-BOX, a vehicle-mounted display, and the like. The vehicle 110 and the user terminal 120 may exchange and share data through wireless communication means such as Wi-Fi, Bluetooth, cellular, and NFC.

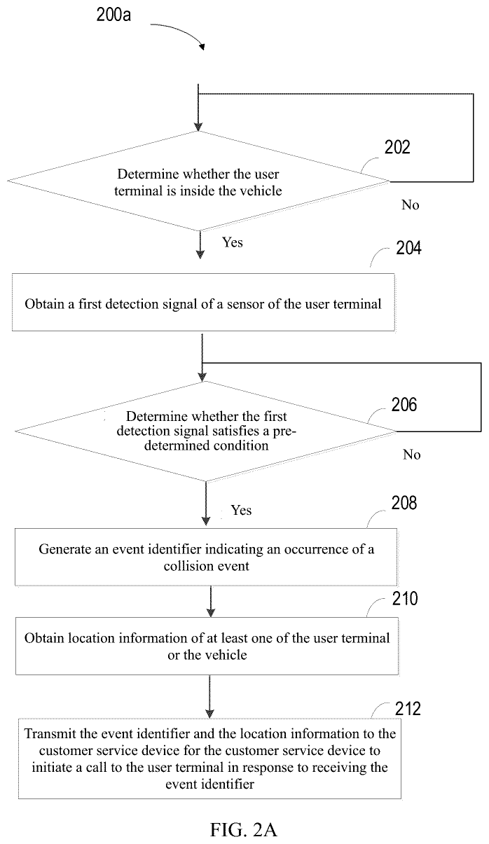

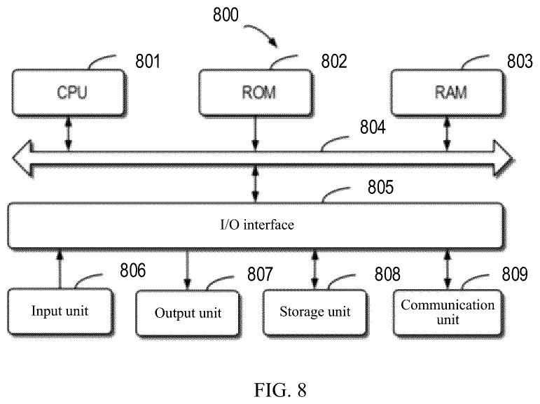

The present disclosure provides a method for customer service. The method will be described below with reference to FIGS. 2A and 2B. FIGS. 2A and 2B are flowcharts of exemplary methods 200a and 200b for customer service according to some embodiments of the present disclosure. For example, the method 200a may be performed by the electronic device 800 shown in FIG. 8, or may be performed by the customer service device 140 shown in FIG. 1. The method 200b may be performed by the electronic device 800 shown in FIG. 8. In some embodiments, the methods 200a and 200b may also be performed at the user terminal 120. The user terminal 120 is taken as an example for description below. It should be understood that both methods 200a and 200b may also include additional actions not shown and/or actions shown that may be omitted, and the scope of the present disclosure is not limited in this regard.

At 202, the user terminal 120 determines whether the user terminal is inside the vehicle associated with the user terminal.

For example, determining whether the user terminal is inside the vehicle associated with the user terminal may include: obtaining, by the user terminal, a traveling speed of the vehicle 110; obtaining a communication connection status between the vehicle-mounted device of the vehicle 110 and the user terminal 120; and based on the traveling speed and the communication connection status, determining whether the user terminal 120 is inside the vehicle 110.

For example, if the user terminal 120 determines that the traveling speed of the current vehicle 110 is greater than or equal to a pre-determined speed threshold, the user terminal 120 obtains the communication connection status between the vehicle-mounted device and the user terminal 120. For example, when the user terminal 120 (e.g., user's mobile phone) establishes a communication connection with the vehicle-mounted device, a communication connection module of the user terminal 120 may notify a pre-determined application running on the user terminal 120 through a broadcast interface (after the user terminal 120 disconnects the communication connection with the vehicle-mounted device, the communication connection module terminates notifying the pre-determined application). Thus, if the user terminal 120 detects the notification of the established communication connection from the broadcast interface through the pre-determined application (e.g., not limited to the vehicle-connected application), and at the same time, determines that the traveling speed of the current vehicle is greater than or equal to the pre-determined speed threshold, the user terminal 120 determines that the user terminal 120 is inside the moving vehicle. For example, the communication connection module of the user terminal 120 may include, but is not limited to, Huawei HiCar. Upon starting up, the Huawei HiCar starts to broadcast the notification to notify the pre-determined application that is also started. In some embodiments, if the user terminal 120 detects that the user terminal 120 has been connected to the vehicle-mounted device for displaying on a vehicle screen and inputting or outputting an audio signal, the user terminal 120 may also determine that the user terminal 120 is inside the vehicle 110.

At 204, if the user terminal determines that the user terminal is inside the vehicle, the user terminal 120 obtains the first detection signal of the sensor of the user terminal 120. The sensor may at least include a gyro sensor, an acceleration sensor, and a geomagnetic sensor.

Generally, when the vehicle is moving smoothly or is parked, the detection signal curve of the sensor of the user terminal presents a relatively smooth or periodically changing curve. When the user terminal device falls or the vehicle collides, the detection signal curve of the sensor will change. For example, as compared with the pre-collision vehicle, substantially large and continuous ripples may be observed in the detection signal curve. Thus, the changing status of the detection signal curve may be used to monitor a type of vibration to assist the determination of the vehicle collision. For example, the gyro sensor configured in the user terminal 120 may obtain an angular velocity by measuring Coriolis acceleration generated by a rotation. In some embodiments, the gyro sensor has three axes configured to detect angular velocities of the user terminal 120 rotating along an X-axis, a Y-axis, and a Z-axis, respectively.

The acceleration sensor is configured to detect an acceleration of the moving user terminal 120. For example, when the acceleration sensor accelerates together with the user terminal 120, a mass block in the acceleration sensor moves in an opposite direction subject to an inertial force. A displacement of the mass block is limited by a spring and a damper coupled with the mass block. The acceleration of the user terminal can be measured through an output voltage.

The geomagnetic sensor is configured to detect an orientation of the user terminal 120. In some embodiments, the geomagnetic sensor has three axes configured to detect orientation data of the user terminal 120 rotating along the X-axis, the Y-axis, and the Z-axis, respectively.

In some embodiments, the type of vibration that causes the user terminal 120 to vibrate may be monitored according to changes of the detection signal curve of the acceleration sensor and/or the gyro sensor, including fluctuations, amplitudes, and curve cycles, etc. Sensor data of the acceleration sensor or the geomagnetic sensor can be used to calculate the attitude and orientation of the user terminal 120. Optionally, an amount of change during an attitude change of the user terminal 120 can be monitored according to the sensor data of the gyro sensor, such that a relative value of the attitude change can be optimized. Based on the sensor data acquired by each sensor and combination filtering calculations, a motion state of the user terminal 120 can be more completely and accurately identified. The motion state may include, but is not limited to, falling, sliding, and collision, etc.

In some embodiments, the user terminal 120 may fuse the acquired detection data of the acceleration sensor and the gyro sensor to generate the first detection signal for indicating a motion vector of the user terminal 120. In some embodiments, the user terminal 120 may fuse the acquired detection data of the acceleration sensor, the gyroscope sensor, and the geomagnetic sensor to generate the first detection signal for indicating the motion vector of the user terminal 120. In some embodiments, the user terminal 120 obtains the detection data of the acceleration sensor as the first detection signal for subsequent matching calculation with a pre-determined curve. In some embodiments, the user terminal 120 obtains the detection data of the gyro sensor as the first detection signal for subsequent matching calculation with the pre-determined curve. In some embodiments, the user terminal 120 further obtains the detection data of the geomagnetic sensor as the first detection signal for subsequent matching calculation with the pre-determined curve.

At 206, the user terminal 120 determines whether the first detection signal satisfies a pre-determined condition associated with a change characteristic of the detection signal indicating the pre-determined vehicle impact process.

In some embodiments, determining that the first detection signal satisfies the pre-determined condition includes: generating a first detection signal curve based on the first detection signal; calculating a similarity between the first detection signal curve and the pre-determined curve; and in response to the similarity falling within a pre-determined threshold range, determining that the first detection signal satisfies the pre-determined condition. For example, the pre-determined curve may be formed based on the obtained detection data of a sensor (e.g., the acceleration sensor and/or the angular velocity sensor) of a mobile phone freely placed in the pre-determined vehicle during a collision of the pre-determined vehicle.

In some embodiments, generating the first detection signal curve based on the first detection signal includes: if the user terminal 120 determines that an amount of change of the first detection signal exceeds a pre-determined change threshold, determining whether the change characteristic of the first detection signal matches a pre-determined characteristics indicating a drop of the mobile phone; and generating the first detection signal curve if it is determined that the change characteristics of the first detection signal do not match the pre-determined characteristics indicating that the drop of the mobile phone.

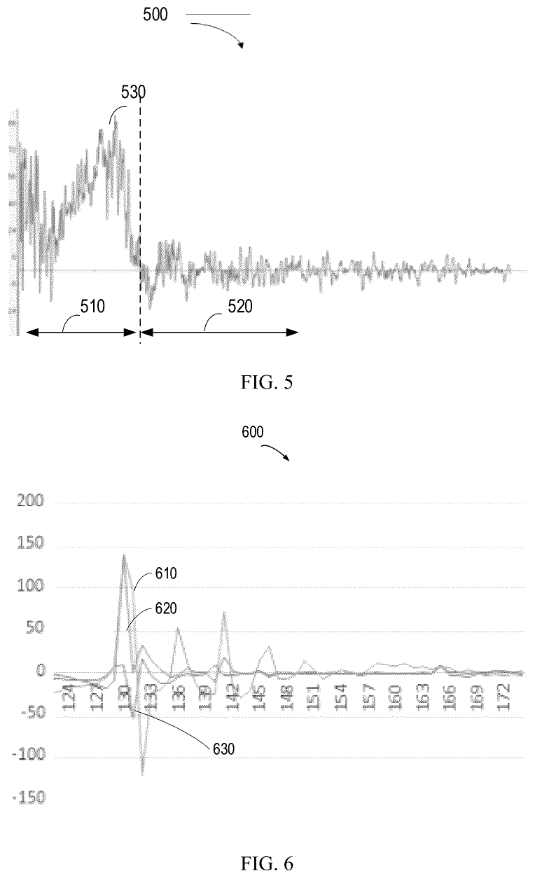

FIG. 6 is a schematic diagram of a sensor detection signal curve 600 in a process of dropping a user terminal according to some embodiments of the present disclosure. As shown in FIG. 6, the abscissa is time, and the ordinate is a detection signal amplitude. A Z-axis direction curve 610 indicates the amount of change of the detection signal in the Z-axis direction of the sensor. An X-axis direction curve 620 indicates the amount of change of the detection signal in the X-axis direction of the sensor. A Y-axis direction curve 630 indicates the amount of change of the detection signal in the Y-axis direction of the sensor. As shown in FIG. 6, the characteristics of the sensor detection signal curve 600 during the drop of the user terminal includes: while the Z-axis direction curve 610 and the X-axis direction curve 620 substantially change in a positive direction, the Y-axis direction curve 630 abruptly changes with a small amplitude in an opposite direction. Thus, if it is determined that the change characteristics of the first detection signal match the characteristics of the sensor detection signal curve 600 in the falling process of the user terminal, it can be determined that the user terminal may accidentally fall in the vehicle.

It should be understood that when the user terminal 120 is accidentally dropped in the vehicle, it is also possible that the first detection signal of the user terminal 120 has a sudden change. The similarity between the first detection signal curve and the pre-determined curve is calculated to avoid erroneously generating the event identifier of the collision event due to the accidental drop of the user terminal in the vehicle, and to reduce unnecessary consumption of computing resources. In some embodiments, when it is confirmed that the first detection signal of the user terminal 120 has a sudden change, and after it is further confirmed that the sudden change does not belong to the sudden change caused by the user terminal falling in the vehicle, the similarity between the first detection signal curve and the pre-built vehicle collision curve can be calculated. Thus, the present disclosure can avoid unnecessary similarity calculation, and generate more accurate event identifier for indicating the occurrence of the collision event.

Studies have shown that the user terminal 120 freely placed in the vehicle has obvious differences in the detection data of the sensor of the user terminal 120 under different conditions such as vehicle collision, smooth vehicle movement, and bumpy vehicle movement. For example, during the smooth vehicle movement, a waveform of the acceleration curve formed based on the detection data of the acceleration sensor of the user terminal 120 is relatively stable. During the vehicle collision, the waveform of the acceleration curve of the user terminal 120 will gradually become flat after abruptly reaching a peak value during the collision. In contrast, during the bumpy vehicle movement, the waveform of the acceleration curve of the user terminal 120 exhibits the characteristics of high frequency fluctuations. Thus, the user terminal 120 can confirm whether the collision event occurs in the current vehicle 110-1 where the user terminal 120 is located by determining whether the detection signal matches a pre-stored pre-determined curve (e.g., the waveform of the acceleration curve of the user terminal 120 during the vehicle collision).

In addition, when the user terminal is located in different positions inside the vehicle (e.g., placed in the center console, door, glove box or seat, or held by the user), the sensor detection signal curve generated by the user terminal during the vehicle collision will be different. Thus, the placement state of the user terminal can be identified and distinguished according to the status detected by the sensor of the user terminal, and some typical collision scenarios can be combined and determined according to the different types and state changes of the detected placement positions, thereby effectively improving a recognition success rate.

In some embodiments, if the user terminal 120 determines that the first detection signal matches at least one curve in a set of pre-determined curves, it is determined that the first detection signal matches the pre-determined curve. For example, the set of pre-determined curves includes a plurality of different pre-determined curves corresponding to the detection signal changes of the pre-determined vehicle during different types of collisions (e.g., rear-end collision, frontal collision, side collision, etc.)

At 208, if the user terminal 120 determines that the first detection signal satisfies the pre-determined condition, the event identifier for indicating the occurrence of the collision event is generated.

In some embodiments, determining that the first detection signal matches the pre-determined curve includes: generating, by the user terminal 120, the first detection signal curve based on the first detection signal; calculating the similarity between the first detection signal curve and the pre-determined curve; and determining that the first detection signal matches the predetermined curve in response to the similarity falling within the pre-determined threshold range.

In some embodiments, for the calculation of the similarity, the user terminal 120 may calculate the similarity between the first detection signal curve and the pre-determined curve based on a Pearson correlation coefficient. The method for calculating the similarity between the first detection signal curve and the pre-determined curve will be described below with reference to equation formula (1):

$$r = \frac{1}{n - 1} {\sum }_{i = 1}^{n} ( \frac{{X}_{i} - \overline{X}}{{σ}_{X}} ) ( \frac{{Y}_{i} - \overline{Y}}{{σ}_{Y}} ) . \qquad ( 1 )$$

In the above formula (1), Xᵢ represents the i-th sample detection data in the first detection signal curve. Yᵢ represents the i-th sample data value in the pre-determined curve. n represents the number of sample data. X̅ represents an average value of the sample detection data in the first detection signal curve. Y̅ represents an average value of the sample data values in the pre-determined curve. σ_{X} represents standard deviation of the sample detection data in the first detection signal curve. 94 _{Y} represents standard deviation of the sample data values in the pre-determined curve.

$$\frac{{X}_{i} - \overline{X}}{{σ}_{X}}$$

represents a standard score for the Xᵢ sample detection data.

$$\frac{{Y}_{i} - \overline{Y}}{{σ}_{Y}}$$

represents a standard score for the Yᵢ sample detection data. r represents the Pearson correlation coefficient of the first detection signal curve and the pre-determined curve.

In some embodiments, the pre-determined threshold range is a range in the vicinity of a value of −1 or 1. For example, the pre-determined threshold range may be [0.8 to 1] and [−0.8 to −1]. For example, if the user terminal 120 determines that the Pearson correlation coefficient r of the first detection signal curve and the pre-determined curve is closer to 0, it indicates that the correlation between the first detection signal curve and the pre-determined curve is weaker (e.g., when r is equal to 0, it indicates that the first detection signal curve is linearly independent of the pre-determined curve). If the user terminal 120 determines that the Pearson correlation coefficient r is closer to −1 or 1, it indicates that the correlation between the first detection signal curve and the pre-determined curve is higher (e.g., when r is equal to −1 or 1, it indicates that the first detection signal curve is highly correlated with the pre-determined curve). For example, if the user terminal 120 determines that the similarity between the first detection signal curve and the pre-determined curve falls within the pre-determined threshold range [0.8 to 1] or [−0.8 to −1], it determines that the first detection signal curve matches the pre-determined curve.

At 210, the user terminal 120 obtains the location information of at least one of the user terminal and the vehicle.

At 212, the user terminal 120 transmits the event identifier and the location information to the customer service device for the customer service device to call the user terminal 120 in response to receiving the event identifier. For example, the user terminal 120 transmits to the customer service device 140 the event identifier for indicating the collision event and the location information of the user terminal 120 and the vehicle 110 when the collision event occurs. The customer service device 140 monitors the event identifier in real time. If the customer service device 140 confirms receipt of the event identifier indicating the collision event, the user terminal 120 is called to confirm further information about the collision event with the user of the user terminal 120.

Alternatively, at 214, the user terminal 120 transmits the event identifier and the location information to the customer service device and initiates a call to the customer service device. For example, the user terminal 120 transmits to the customer service device 140 the event identifier indicating the collision event and the location information of the user terminal 120 and the vehicle 110 when the collision event occurs. When the user terminal 120 transmits the event identifier and the location information to the customer service device 140, the user terminal 120 may also invoke a call function to initiate an active call to the customer service device 140. Alternatively, the user terminal 120 may also control the call module of the vehicle 110 to initiate an active call to the customer service device 140 through the connection with the vehicle 110 while transmitting the event identifier and the location information to the customer service device 140.

In the above solution, the detection signal of the sensor of the user terminal 120 inside the vehicle is acquired. If the detection signal matches the pre-determined curve indicating the data signal change characteristics in the pre-determined vehicle collision process, the method provided by the present disclosure generates the event identifier indicating the occurrence of a collision event and obtains the location information of at least one of the user terminal or the vehicle. The method provided by the present disclosure automatically and timely identifies the status of the vehicle collision and other accidents. In addition, by transmitting the generated event identifier and the acquired location information to the customer service device for the customer service device to call the user terminal according to the event identifier, or by transmitting the generated event identifier and the acquired location information to the customer service device and initiating the call to the customer service device, the method provided by the present disclosure timely and accurately obtains the relevant location, and timely and automatically contacts the user terminal to confirm the exact status of the collision and other accidents and to obtain further information about the user and the vehicle. Thus, the status and location of the collision and other accidents can be more accurately confirmed.

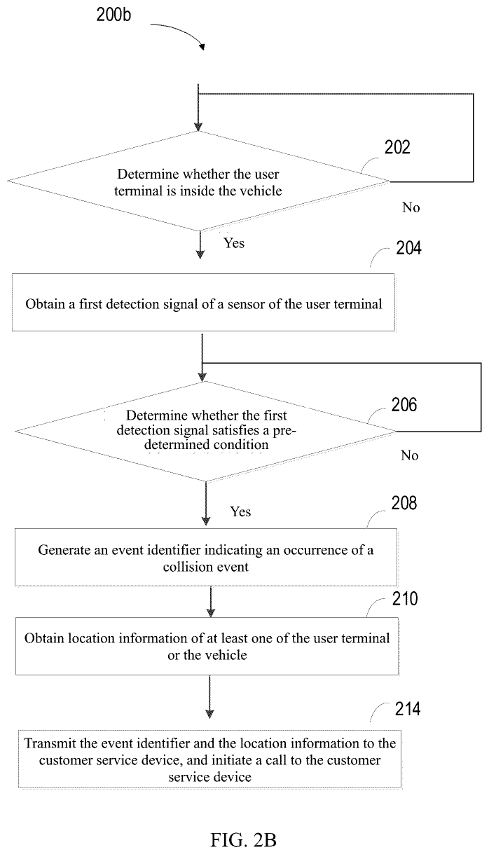

The embodiments of the present disclosure further provide a method 300 for generating and transmitting a rescue signal. FIG. 3 is a flowchart of an exemplary method 300 for generating and transmitting a rescue signal according to some embodiments of the present disclosure. It should be understood that the method 300 may be performed, for example, at the electronic device 800 shown in FIG. 8. The method 300 may also be performed at the customer service device 140 shown in FIG. 1. It should be understood that the method 300 may also include additional actions not shown and/or the actions shown may be omitted, and the scope of the present disclosure is not limited in this regard.

At 302, the customer service device 140 determines whether the called user terminal is connected.

At 304, if the customer service device 140 determines that the called user terminal is connected, a response message of the user terminal is generated.

At 306, the customer service device 140 determines whether a positive response regarding the occurrence of the event has been received from the user.

If the called user terminal is not connected, at 308, the customer service device 140 determines whether the response message from the user terminal has not been received within a pre-determined time interval.

If the customer service device 140 determines that no response message is received from the user terminal within the pre-determined time interval, or the positive response regarding the occurrence of the event is received from the user, at 310, the rescue signal is generated. The rescue signal at least indicates the location information and the identifier of the vehicle. The identifier of the vehicle is pre-stored in the customer service device through a pre-determined application. In some embodiments, if the customer service device 140 determines that the response message is not received from the user terminal within the pre-determined time interval, another user terminal associated with the user terminal is called. The identifier of the associated user terminal is stored at the customer service device.

At 312, the customer service device 140 transmits the rescue signal. The customer service device 140 can automatically transmit the rescue signal to the computing device of the rescue agency. The customer service device 140 can also transmit the rescue signal to other vehicles within a pre-determined range around the vehicle (e.g., the vehicle 110-1) that has collided.

In some embodiments, transmitting the rescue signal includes: the customer service device 140 searches for other user terminals 120-N and other vehicles 110-N within the pre-determined range from the vehicle 110-1 and logging into the pre-determined application through the pre-determined application based on the location information. The customer service device 140 transmits the rescue signal to the other user terminals 120-N and the vehicle-mounted devices of the other vehicles 110-N.

In the above solution, the method provided by the present disclosure can automatically transmit the rescue signal indicating the location information of the collision accident according to the connection status of the called user terminal, thereby providing assistance to the accident vehicle or the user in time.

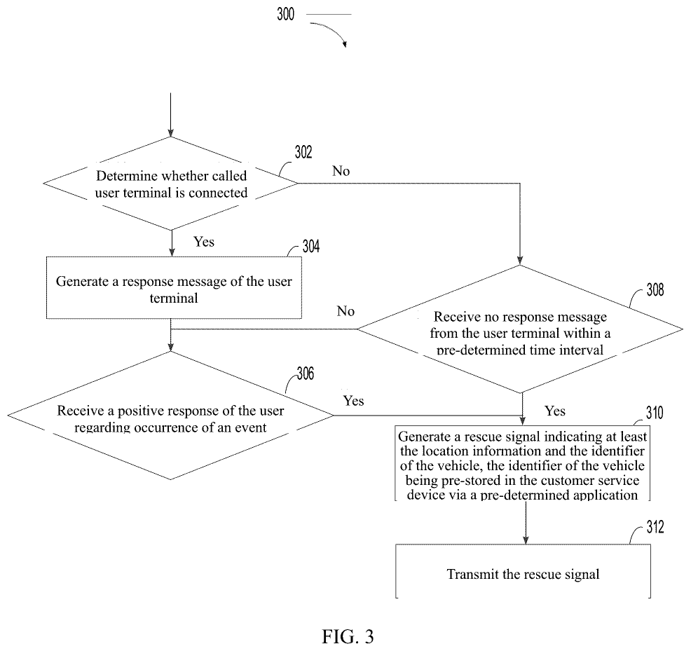

In some embodiments, the present disclosure further provides a method 400 for generating an event identifier indicating an occurrence of a collision event. FIG. 4 is a flowchart of an exemplary method 400 for generating an event identifier for indicating an occurrence of a collision event according to some embodiments of the present disclosure. It should be understood that the method 400 may be performed, for example, at the electronic device 800 shown in FIG. 8. The method 400 may also be performed at the customer service device 140 shown in FIG. 1. In some embodiments, the method 400 may also be performed at the user terminal 120. It should be understood that the method 400 may also include additional actions not shown and/or the actions shown may be omitted, and the scope of the present disclosure is not limited in this regard.

At 402, the user terminal 120 obtains an acceleration detection signal of an acceleration sensor of the vehicle.

At 404, the user terminal 120 generates an acceleration curve of the vehicle based on the acceleration detection signal. The acceleration of the vehicle reflects a state change at each moment when the vehicle is traveling (or colliding). Through the acceleration curve of the vehicle, it can be determined that a vehicle body is contacted and impacted at each moment.

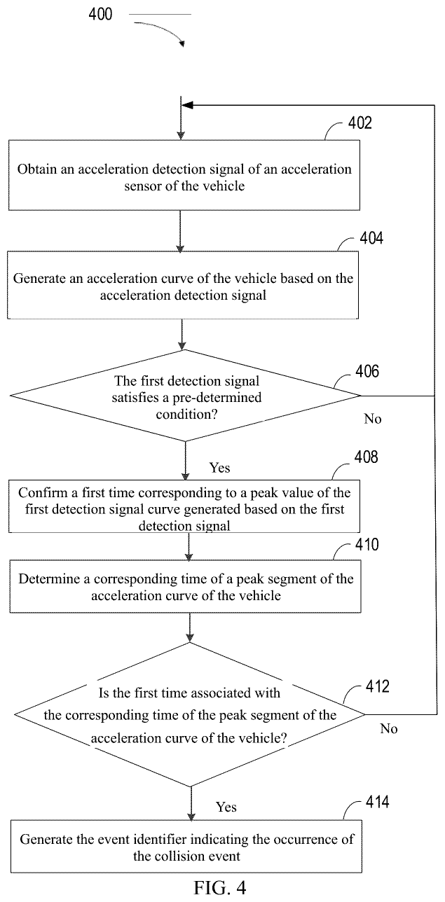

FIG. 5 is a schematic diagram of an exemplary acceleration curve 500 of a vehicle in a collision according to some embodiments of the present disclosure. Studies found that, for example, in the process of a frontal collision of a vehicle, the acceleration curve 500 generated by the vehicle during the collision as shown in FIG. 5 can generally be divided into a first stage 510 and a second stage 520. In the first stage 510, the vehicle's acceleration profile peaks 530 in a relatively short period of time. In the second stage 520, part of kinetic energy of the vehicle is converted into deformation energy due to the deformation of the vehicle body. For example, the energy absorbing components of the vehicle body are deformed. In this stage, the acceleration curve of the vehicle enters a relatively stable stage.

At 406, the user terminal 120 determines whether the first detection signal satisfies a pre-determined condition. If it is determined that the first detected signal does not satisfy the pre-determined condition, for example, if the user terminal 120 determines that a new first detection signal does not match the pre-determined curve, 402 is executed.

At 408, if the user terminal 120 determines that the first detection signal satisfies the pre-determined condition, it confirms a first time corresponding to the peak value of the first detection signal curve generated based on the first detection signal. For example, if the similarity between the acceleration curve of the user terminal 120 and the pre-determined curve belongs to the pre-determined threshold range, the user terminal 120 may determine that the first detection signal matches the pre-determined curve, and then determine the first time corresponding to the acceleration peak value of the acceleration curve of the user terminal 120.

At 410, the user terminal 120 determines the corresponding time of the peak segment of the acceleration curve of the vehicle. Researches show that during a vehicle collision, the waveform of the acceleration curve of the user terminal 120 freely placed inside the vehicle will suddenly reach the acceleration peak in a short time after a collision moment, and then gradually become flat. Thus, the first time corresponding to the acceleration peak value of the user terminal is relatively close to the collision time. As mentioned above, the time when the peak value of the vehicle acceleration curve appears during the vehicle collision is also relatively close to the actual collision time of the vehicle. Thus, the correlation between the peak corresponding time of the acceleration curve of the user terminal 120 and the peak time of the vehicle acceleration curve can be used to determine whether the user terminal and the vehicle simultaneously encounter an event that can cause the acceleration to peak instantaneously, such as a collision event.

At 412, the user terminal 120 confirms whether the first time is associated with the corresponding time of the peak segment of the acceleration curve of the vehicle. Determining whether the first time is associated with the corresponding time of the sudden change section includes: determining whether the first time and the corresponding time of the sudden change section are synchronized; or determining the interval between the first time and the corresponding time of the sudden change section is less than or equal to a pre-determined time interval.

At 414, if the user terminal 120 confirms that the first time is associated with the corresponding time of the peak segment of the acceleration curve of the vehicle, an event identifier is generated indicating the occurrence of the collision event. If the user terminal 120 determines that the first time is not associated with the corresponding time of the peak section of the acceleration curve of the vehicle, 402 is executed. This is because when the user terminal freely placed inside the vehicle and the vehicle simultaneously face the inertial force caused by the vehicle collision event, the acceleration of the two has a certain correlation in the time corresponding to the sudden peak value (e.g., synchronization can be observed, or the difference is less than or equal to the pre-determined time interval). If the user terminal inside the vehicle falls unexpectedly or slides due to the vehicle turning, the acceleration curve of the user terminal will show some sudden changes. If the user terminal 120 determines that the peak time correlated with the sudden change section of the vehicle acceleration curve does not appear at this time, the user terminal 120 determines that no vehicle collision event has occurred.

In the above solution, by confirming that the new first detection signal of the user terminal matches the pre-determined curve, and that the first time is associated with the corresponding time of the peak section of the acceleration curve of the vehicle, the signal indicating the occurrence of the collision event is generated. With the event identifier, the present disclosure can avoid misjudgment about a collision event caused by abnormal reasons such as accidental drop of the user terminal. Thus, the generated event identifier can more accurately indicate the occurrence of an actual vehicle collision event.

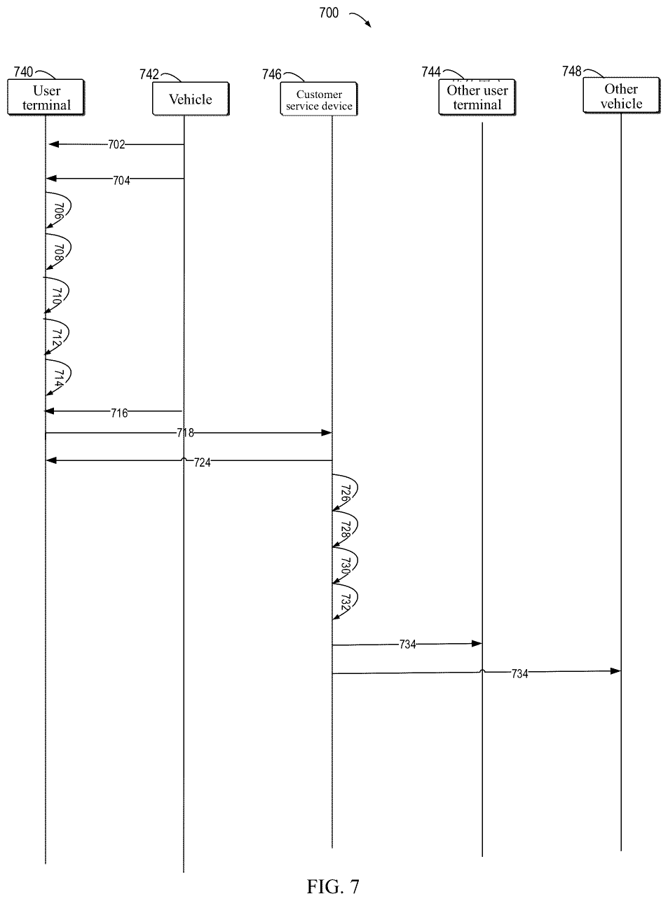

The present disclosure provides another method for customer service, which will be described below with reference to FIG. 7. FIG. 7 is a schematic diagram of data exchange in an exemplary method 700 for customer service according to some embodiments of the present disclosure. It should be understood that the method 700 may be performed, for example, at the electronic device 800 shown in FIG. 8. The method 700 may also be performed at the customer service device 140 shown in FIG. 1. In some embodiments, the method 700 may also be performed at the user terminal 120. It should be understood that the method 700 may also include additional actions not shown and/or the actions shown may be omitted, and the scope of the present disclosure is not limited in this regard.

As shown in FIG. 7, the data exchange involves a user terminal 740, a vehicle 742, another user terminal 744, another vehicle 748, and a customer service device 746. For example, the vehicle 742 may be the collision vehicle, the another vehicle 748 may be located within a pre-determined distance from the vehicle 742. For example, the user terminal 740 may be a mobile phone of an owner of the vehicle 742, and the another user terminal 744 may be another mobile phone of another owner of the another vehicle 748.

At the user terminal 740, at 702, the traveling speed of the vehicle 742 is obtained.

At 704, a communication connection status of the vehicle-mounted device of the vehicle 742 and the user terminal 740 is obtained.

At 706, whether the user terminal 740 is inside the vehicle 742 is determined based on the traveling speed and the communication connection status.

At 708, if it is determined that the user terminal 740 is inside the vehicle 742, a first detection signal of a sensor (including a gyro sensor and an acceleration sensor) of the user terminal 740 is obtained.

At 710, based on the first detection signal, a first detection signal curve is generated.

At 712, a similarity between the first detection signal curve and a pre-determined curve is calculated.

At 714, if it is determined that the similarity falls within a pre-determined threshold range, the first detection signal is determined to match the pre-determined curve to generate an event identifier indicating an occurrence of a collision event.

At 716, location information for at least one of the user terminal 740 or the vehicle 742 is obtained.

At 718, the event identifier and the location information are transmitted to a customer service device 746.

At the customer service device 746, at 724, if it is determined that the event identifier has been received, the user terminal 740 is called.

At 726, whether the called user terminal 740 is connected is determined.

At 728, if it is determined that the called user terminal 740 is connected, a response message of the user terminal 740 is generated; if it is determined that no response message is received from the user terminal 740 within a pre-determined time interval, the another user terminal 744 associated with the user terminal 740 is called.

At 730, if no response message is received from the user terminal within the pre-determined time interval or a positive response from the user about the occurrence of the event is received, a rescue signal is generated, and the rescue signal indicates at least the location information and the identifier of the vehicle. The identifier of the vehicle is pre-stored in the customer service device 746 via a pre-determined application.

At 732, based on the obtained location information, other user terminals and other vehicles logged into the pre-determined application and located within the pre-determined range from the vehicle are searched via the pre-determined application.

At 734, the rescue signal is transmitted to the another user terminal 744 and the vehicle-mounted device of the another vehicle 748.

At the another user terminal 744 and the another vehicle 748, the rescue signal is received.

FIG. 8 is a schematic structural diagram of an exemplary electronic device 800 according to some embodiments of the present disclosure. The electronic device 800 may be a computing device. The electronic device 800 may be an apparatus for implementing the methods 200, 300 and 400 shown in FIGS. 2, 3 and 4. As shown in FIG. 8, the electronic device 800 includes a central processing unit (CPU) 801. The CPU 801 may be configured to perform various appropriate actions and processes according to computer program instructions stored in a read only memory (ROM) 802 or computer program instructions loaded into a random-access memory (RAM) 803 from a storage unit 808. In the RAM, various programs and data required for the operation of the electronic device 800 can also be stored. The CPU, ROM, and RAM are connected to each other through a bus 804. An input/output (I/O) interface 805 is also connected to bus 804.

Various components in the electronic device 800 are connected to an input/output (I/O) 805, which include: an input unit 806, an output unit 807, the storage unit 808, and a communication unit 809. The CPU 801 performs the various methods and processes described above, e.g., the methods 200, 300, and 400. For example, in some embodiments, the methods 200, 300 and 400 may be implemented as a computer software program stored on a machine-readable medium, such as the storage unit 808. In some embodiments, part or all of the computer software program may be loaded and/or installed on the electronic device 800 via the ROM and/or the communication unit 809. When the computer software program is loaded into the RAM 803, and executed by the CPU 801, one or more operations of the methods 200, 300 and 400 described above may be performed. Alternatively, in some other embodiments, the CPU 801 may be configured to perform one or more actions of the methods 200, 300 and 400 by any other suitable means (e.g., by means of firmware).

It should be further noted that the present disclosure may be a method, an electronic device, a system and/or a computer program product. The computer program product may include a computer-readable storage medium having computer-readable program instructions loaded thereon for carrying out various aspects of the present disclosure.

The computer-readable storage medium may be a tangible device that can hold and store instructions for use by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples (non-exhaustive list) of computer-readable storage medium include: portable computer disks, hard disks, random-access memory (RAM), read only memory (ROM), erasable programmable read only memory (EPROM) or flash memory, static random-access memory (SRAM), portable compact disk read only memory (CD-ROM), digital versatile disk (DVD), memory sticks, floppy disks, mechanically coded devices such as hole cards or raised structures in grooves printed with instructions stored thereon, and any suitable combination thereof. The computer-readable storage medium, as used herein, is not to be construed as transient signals per se, such as radio waves or other freely propagating electromagnetic waves, electromagnetic waves propagating through waveguides or other transmission media (e.g., light pulses through fiber optic cables), or through electrical wires transmitted electrical signals.

The computer-readable program instructions described herein may be downloaded to various computing/processing devices from the computer-readable storage medium, or to an external computer or external storage device over a network, such as the Internet, a local area network, a wide area network, and/or a wireless network. The network may include copper cable transmission, fiber optic transmission, wireless transmission, routers, firewalls, switches, gateway computers, and/or edge servers. A network adapter card or network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine dependent instructions, microcode, firmware instructions, state setting data, or in one or more source or object codes written in any combination of programming languages, including object-oriented programming languages such as Smalltalk, C++, etc., and conventional procedural programming languages such as C or similar programming languages. The computer readable program instructions may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any kind of network, including the local area network (LAN) or the wide area network (WAN), or may be connected to the external computer (e.g., using an Internet service provider through the Internet connection). In some embodiments, custom electronic circuits, such as programmable logic circuits, field programmable gate arrays (FPGAs), or programmable logic arrays (PLAs), can be customized by utilizing state information of the computer-readable program instructions. The computer-readable program instructions are executed to implement various aspects of the present disclosure.

Aspects of the present disclosure are described herein with reference to flowcharts and/or schematic diagrams of the methods, the electronic devices (systems), and computer program products according to the embodiments of the present disclosure. It should be understood that each step of the flowcharts and/or step diagrams, and combinations of steps in the flowcharts and/or step diagrams, can be implemented by the computer-readable program instructions.

The computer-readable program instructions may be provided to a processor in a voice interaction device, a general-purpose computer, a special-purpose computer, or a processing unit of other programmable data processing devices, thereby producing a machine in which the instructions, when being executed by the processing elements of computers and other programmable data processing devices, produce means for implementing the functions/acts specified in one or more of the blocks in the flowcharts and/or step diagrams. The computer-readable program instructions can also be stored in the computer-readable storage medium. The instructions cause the computer, programmable data processing apparatus and/or other equipment to operate in a specific manner, such that the computer-readable medium on which the instructions are stored includes an article of manufacture comprising instructions for implementing various aspects of the functions/acts specified in one or more of the blocks in the flowcharts and/or step diagrams.

The computer-readable program instructions can also be loaded onto the computer, other programmable data processing apparatus, or other equipment to cause a series of operational steps to be performed on the computer, other programmable data processing apparatus, or other equipment to produce a computer process of implementation such that the instructions being executed on the computer, other programmable data processing apparatus, or other device perform the functions/acts specified in one or more of the blocks in the flowcharts and/or step diagrams.

The flowcharts and step diagrams in the drawings illustrate the architecture, functionality, and operation of possible implementations of the electronic devices, methods and computer program products according to various embodiments of the present disclosure. In this regard, each block in the flowcharts or step diagrams may represent a module, segment, or portion of instructions that contains one or more executable instructions for implementing specified logical functions. In some embodiments, the functions noted in the blocks and/or steps may occur out of the order noted in the drawings. For example, two consecutive steps may, in fact, be executed substantially concurrently, or the steps may sometimes be executed in a reverse order, depending upon the functionality involved. It should also be noted that each block of the step diagrams and/or flowcharts, and combinations of blocks in the step diagrams and/or flowcharts, may be implemented using dedicated hardware-based systems that perform the specified functions or actions, or may be implemented in a combination of special-purpose hardware and computer instructions.

Various embodiments of the present disclosure have been described above, and the above descriptions are exemplary, not exhaustive, and not limiting to the disclosed embodiments. Numerous modifications and variations will be apparent to those of ordinary skill in the art without departing from the scope and spirit of the described embodiments. The terminology used herein was chosen to best explain the principles of the embodiments, the practical application or technical improvement in the marketplace, or to enable others of ordinary skill in the art to understand the embodiments disclosed herein.

The above are only optional embodiments of the present disclosure, and are not intended to limit the present disclosure. For those skilled in the art, the present disclosure may have various modifications and changes. Any modifications, equivalent replacements, improvements, etc. made within the spirit and principles of the present disclosure should be included within the protection scope of the present disclosure.

1. A method for customer service, comprising:
determining whether a user terminal is inside a vehicle, the vehicle being associated with the user terminal;
in response to the user terminal being determined to be inside the vehicle, obtaining a first detection signal of a sensor of the user terminal;
in response to the first detection signal satisfying a pre-determined condition, generating an event identifier indicating an occurrence of a collision event, the pre-determined condition being associated with change characteristics of a detection signal in a pre-determined vehicle collision process;
obtaining location information of at least one of the user terminal or the vehicle; and
transmitting the event identifier and the location information to a customer service device for the customer device to initiate a call to the user terminal in response to receiving the event identifier to confirm a connection status of the user terminal.

2. The method according to claim 1, wherein:
the vehicle is a moving vehicle.

3. The method according to claim 1, wherein determining whether the first detection signal satisfies the pre-determined condition includes:
based on the first detection signal, generating a first detection signal curve;
calculating a similarity between the first detection signal curve and a pre-determined curve, the pre-determined curve indicating the change characteristics of the detection signal in the pre-determined vehicle collision process; and
in response to the similarity being determined to fall within a pre-determined threshold range, determining that the first detection signal satisfies the pre-determined condition.

4. The method according to claim 3, wherein:
the sensor at least includes a gyro sensor and an acceleration sensor.

5. The method according to claim 3, wherein generating the first detection signal curve based on the first detection signal includes:
in response to an amount of change of the first detection signal being determined to exceed a pre-determined change threshold, determining whether the change characteristics of the first detection signal match pre-determined characteristics indicating a drop of a mobile phone; and
in response to the change characteristics of the first detection signal not matching the pre-determined characteristics indicating the drop of the mobile phone, generating the first detection signal curve.

6. The method according to claim 1, further comprising:
in response to the called user terminal being determined to be connected, generating a response message of the user terminal; and
in response to no response message being determined to be received from the user terminal within a pre-determined time interval, initiating a call to another user terminal associated with the user terminal, the identifier of the associated user terminal being stored in the customer service device.

7. The method according to claim 1, further comprising:
in response to at least one of following conditions being satisfied, generating and transmitting a rescue signal by the customer service device:
receiving no response message of the user terminal within the pre-determined time interval; and
receiving a positive response of a user regarding the occurrence of the collision event;
wherein the rescue signal at least indicates the location information and the identifier of the vehicle, and the identifier of the vehicle is pre-stored in the customer service device through a pre-determined application.

8. The method according to claim 7, wherein transmitting the rescue signal includes:
based on the location information, searching, through the pre-determined application, other user terminals and other vehicles that are located within a pre-determined range from the vehicle and logged into the pre-determined application; and
transmitting the rescue signal to the other user terminals and vehicle-amounted devices of the other vehicles.

9. The method according to claim 3, further comprising:
obtaining an acceleration detection signal of an acceleration sensor of the vehicle; and
generating an acceleration curve of the vehicle based on the acceleration detection signal.

10. The method according to claim 9, wherein generating the event identifier indicating the occurrence of the collision event in response to the first detection signal being determined to satisfy the pre-determined condition includes:
in response to the first detection signal being determined to satisfy the pre-determined condition, confirming a first time corresponding to a peak value of the first detection signal curve generated based on the first detection signal;
determining a corresponding time of a peak segment of the acceleration curve of the vehicle;
determining whether the first time is associated with the corresponding time of the peak segment; and
in response to the first time being determined to be associated with the corresponding time of the peak segment, generating the event identifier indicating the occurrence of the collision event.

11. The method according to claim 1, wherein determining whether the user terminal is inside the vehicle includes:
obtaining a traveling speed of the vehicle;
obtaining a communication connection status of the vehicle-mounted device of the vehicle and the user terminal; and
based on the traveling speed and the communication connection status, determining whether the user terminal is inside the vehicle.

12. A computing device, comprising:
a memory configured to store one or more computer programs; and
a processor coupled to the memory and configured to execute the one or more computer programs for the computing device to perform:
determining whether a user terminal is inside a vehicle, the vehicle being associated with the user terminal;
in response to the user terminal being determined to be inside the vehicle, obtaining a first detection signal of a sensor of the user terminal;
in response to the first detection signal satisfying a pre-determined condition, generating an event identifier indicating an occurrence of a collision event, the pre-determined condition being associated with change characteristics of a detection signal in a pre-determined vehicle collision process;
obtaining location information of at least one of the user terminal or the vehicle; and
transmitting the event identifier and the location information to a customer service device for the customer device to initiate a call to the user terminal in response to receiving the event identifier to confirm a connection status of the user terminal.

13. A non-volatile computer-readable storage medium storing machine executable instructions, wherein:
when being executed by a machine, the machine executable instructions cause the machine to perform:
determining whether a user terminal is inside a vehicle, the vehicle being associated with the user terminal;
in response to the user terminal being determined to be inside the vehicle, obtaining a first detection signal of a sensor of the user terminal;
in response to the first detection signal satisfying a pre-determined condition, generating an event identifier indicating an occurrence of a collision event, the pre-determined condition being associated with change characteristics of a detection signal in a pre-determined vehicle collision process;
obtaining location information of at least one of the user terminal or the vehicle; and
transmitting the event identifier and the location information to a customer service device for the customer device to initiate a call to the user terminal in response to receiving the event identifier to confirm a connection status of the user terminal.

14. The method according to claim 1, further comprising:
after transmitting the event identifier and the location information to the customer service device, initiating a call to the customer service device.

15. The computing device according to claim 12, wherein:
the vehicle is a moving vehicle.

16. The computing device according to claim 12, wherein when determining whether the first detection signal satisfies the pre-determined condition, the processor is further configured to:
based on the first detection signal, generate a first detection signal curve;
calculate a similarity between the first detection signal curve and a pre-determined curve, the pre-determined curve indicating the change characteristics of the detection signal in the pre-determined vehicle collision process; and
in response to the similarity being determined to fall within a pre-determined threshold range, determine that the first detection signal satisfies the pre-determined condition.

17. The computing device according to claim 16, wherein when generating the first detection signal curve based on the first detection signal, the processor is further configured to:
in response to an amount of change of the first detection signal being determined to exceed a pre-determined change threshold, determine whether the change characteristics of the first detection signal match pre-determined characteristics indicating a drop of a mobile phone; and
in response to the change characteristics of the first detection signal not matching the pre-determined characteristics indicating the drop of the mobile phone, generate the first detection signal curve.

18. The non-volatile computer-readable storage medium according to claim 13, wherein:
the vehicle is a moving vehicle.

19. The non-volatile computer-readable storage medium according to claim 13, wherein when determining whether the first detection signal satisfies the pre-determined condition, the machine is further configured to:
based on the first detection signal, generate a first detection signal curve;
calculate a similarity between the first detection signal curve and a pre-determined curve, the pre-determined curve indicating the change characteristics of the detection signal in the pre-determined vehicle collision process; and
in response to the similarity being determined to fall within a pre-determined threshold range, determine that the first detection signal satisfies the pre-determined condition.

20. The non-volatile computer-readable storage medium according to claim 20, wherein the machine is further configured to:
in response to an amount of change of the first detection signal being determined to exceed a pre-determined change threshold, determine whether the change characteristics of the first detection signal match pre-determined characteristics indicating a drop of a mobile phone; and
in response to the change characteristics of the first detection signal not matching the pre-determined characteristics indicating the drop of the mobile phone, generate the first detection signal curve.
